(19) United States
(12) Patent Application Publication
(10) Pub. No.: US 2021/0313705 A1
(43) Pub. Date: Oct. 7, 2021

(54) RF ELEMENT DESIGN FOR IMPROVED TUNING RANGE

(71) Applicant: Kymeta Corporation, Redmond, WA (US)

(72) Inventors: Steven Howard Linn, Hillsboro, OR (US); Cagdas Varel, Seattle, WA (US)

(21) Appl. No.: 17/218,781

(22) Filed: Mar. 31, 2021

Related U.S. Application Data
(60) Provisional application No. 63/005,070, filed on Apr. 3, 2020.

(51) Int. Cl. H01Q 21/06

(52) U.S. Cl. CPC H01Q 21/065

(57) ABSTRACT

An antenna and method of using the same are described. In one embodiment, the antenna comprise an array of radio-frequency (RF) radiating antenna elements, wherein each RF radiating antenna element comprises a first conductor stack containing one or more metal layers and having a first set of one or more conductive layers covering a first side of the first conductive stack; a second conductor stack, separated from the first conductor stack, containing one or more conductive layers and having a second set of one or more conductive layers covering a second side of the second conductive stack; and liquid crystal (LC) between the first and second sides of the first and second conductor stacks, respectively.

### PRIORITY

This application claims benefit of priority from U.S. Provisional Application No. 63/005,070, titled “RF element design for improved tuning range” and filed Apr. 3, 2020, which is hereby incorporated by reference.

### FIELD OF THE INVENTION

Embodiments of the present invention are related to wireless communication; more particularly, embodiments of the present invention are related to antennas with liquid-crystal (LC)-based antenna elements that use protective layers on electrodes.

### BACKGROUND

In an electronically steerable antenna having radio-frequency (RF) radiating antenna elements, a key performance parameter of a RF element design is the RF frequency range over which the resonance of the RF element can be tuned. In one embodiment, the tuning of the resonance frequency of the RF element of a metamaterial of an antenna is enabled by changing the capacitance of the RF element according the equation:

F∝1/√LC

where f is the resonance frequency L is the impedance and C is the capacitance of the RF element. One method of changing the capacitance of an RF element is to use a dielectric material with a tunable permittivity. One such dielectric is liquid crystal.

The tuning range of an RF element using liquid crystal as the tunable is controlled by several factors. In order to use liquid crystal (LC) as a tunable dielectric, the LC is placed between two electrodes and an electric field is applied, thereby changing the permittivity of the LC. Typically, parts of the electrode/LC/electrode tuning structure include additional dielectrics which are not tunable. These additional dielectrics are deposited on the electrodes and perform, for example, the functions of providing alignment features for the LC molecules and prevent the electrode materials and the LC from coming into contact with each other. This is important because there may be reactivity between the LC and the high conductivity metal materials required by the RF element.

The presence of non-tuning dielectrics between the electrode and the LC layer has detrimental effects. One effect is that some of the drive voltage is dropped between the electrode and the LC, thereby reducing the effective voltage that can be applied across the LC. Another effect is that the amount of tunable dielectric that is between the electrodes is reduced by the presence of non-tunable dielectric layers between the electrodes, thereby reducing the thickness of material between the electrodes that can be tuned.

### SUMMARY

An antenna and method of using the same are described. In one embodiment, the antenna comprise an array of radio-frequency (RF) radiating antenna elements, wherein each RF radiating antenna element comprises a first conductor stack containing one or more metal layers and having a first set of one or more conductive layers covering a first side of the first conductive stack; a second conductor stack, separated from the first conductor stack, containing one or more conductive layers and having a second set of one or more conductive layers covering a second side of the second conductive stack; and liquid crystal (LC) between the first and second sides of the first and second conductor stacks, respectively.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a structure of a liquid-crystal (LC)-based metamaterial antenna element.

FIG. 2 illustrates one embodiment of a structure of a liquid-crystal (LC)-based metamaterial antenna element having patch and iris conductor stacks covered with non-conductive layers.

FIG. 3 illustrates one embodiment of a structure of a liquid-crystal (LC)-based metamaterial antenna element having a single, non-conductive layer covering each of the patch and iris conductor stacks.

FIG. 4 illustrates one embodiment of a structure of a liquid-crystal (LC)-based metamaterial antenna element having two or more, non-conductive layers covering each of the patch and iris conductor stacks.

FIG. 5 illustrates one embodiment of a structure of a liquid-crystal (LC)-based metamaterial antenna element having one or more, non-conductive layers covering each of the top and bottom conductor stacks.

FIG. 6 illustrates an aperture having one or more arrays of antenna elements placed in concentric rings around an input feed of the cylindrically fed antenna.

FIG. 7 illustrates a perspective view of one row of antenna elements that includes a ground plane and a reconfigurable resonator layer.

FIG. 8A illustrates one embodiment of a tunable resonator/slot.

FIG. 8B illustrates a cross section view of one embodiment of a physical antenna aperture.

FIG. 9A illustrates a portion of the first iris board layer with locations corresponding to the slots.

FIG. 9B illustrates a portion of the second iris board layer containing slots.

FIG. 9C illustrates patches over a portion of the second iris board layer.

FIG. 9D illustrates a top view of a portion of the slotted array.

FIG. 10 illustrates a side view of one embodiment of a cylindrically fed antenna structure.

FIG. 11 illustrates another embodiment of the antenna system with an outgoing wave.

FIG. 12 illustrates one embodiment of the placement of matrix drive circuitry with respect to antenna elements.

FIG. 13 illustrates one embodiment of a TFT package.

FIG. 14 is a block diagram of another embodiment of a communication system having simultaneous transmit and receive paths.

### DETAILED DESCRIPTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

An antenna having radio-frequency (RF) radiating antenna elements that each has an improved tuning range and method for using the same are described. In one embodiment, the RF radiating antenna elements comprises surface scattering metamaterial antenna elements. Examples of such antennas (e.g., electronically steerable antennas having LC-based metamaterial RF radiating antenna elements, etc.) are described in more detail below; however, the techniques described herein are not limited to such antenna and may be used in other antennas.

In one embodiment, some layers of non-tunable dielectric are eliminated from the antenna elements and replaced with thin layers of non-reactive material that can protect the high conductivity electrode metals of the RF antenna element, one layer each to cover the electrode stacks (e.g., iris and patch conductor stacks). By doing so, the tuning of the RF element is improved.

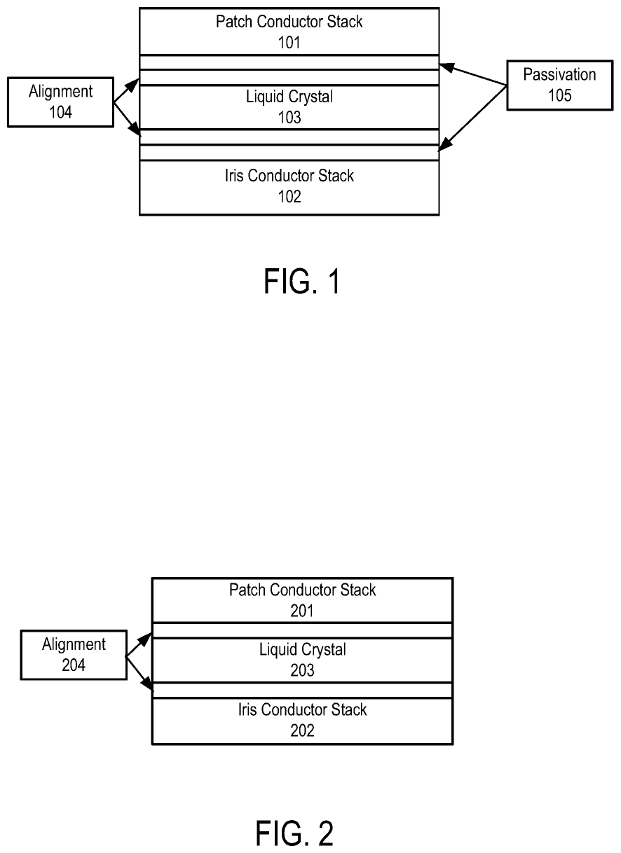

FIG. 1 illustrates a structure of a liquid-crystal (LC)-based metamaterial antenna element. Referring to FIG. 1, the structure includes a patch conductor stack 101, an iris conductor stack 102 and LC 103 between patch conductor stack 101 and iris conductor stack 102. Passivation layers 105 are attached to sides of patch conductor stack 101 and iris conductor stack 102 that face LC 103. Alignment layers 104 for aligning the LC during the on and off phases of the antenna element are attached to passivation layers 105 adjacent to LC 103.

In one embodiment, the antenna comprises an array of radio-frequency (RF) radiating antenna elements. Each RF radiating antenna element includes a first conductor stack, a second conductor stack with LC between the conductor stacks. In contrast to the structure of FIG. 1, each of the conductor stacks in the structure of FIG. 2 contain one or more conductive layers covering the side of the conductive stack that faces the LC within the structure.

FIG. 2 illustrates one embodiment of a structure of a liquid-crystal (LC)-based metamaterial antenna element having patch and iris conductor stacks covered with non-conductive layers. Referring to FIG. 2, the structure includes a patch conductor stack 201, an iris conductor stack 202 and LC 203 between patch conductor stack 201 and iris conductor stack 202. In one embodiment, alignment layers 204 are attached to patch conductor stack 201 and iris conductor stack 202 and are used to give a starting point and an initial order to the LC and are used for aligning the LC according to this initial order (with the LC being thereafter being controlled by applying a voltage during the on and off phases of the antenna element.). In one embodiment, alignment layers 204 cover the entire sides of patch conductor stack 201 and iris conductor stack 202 that contact LC 203.

In one embodiment, patch conductor stack 201 comprises one or more patch metal layers attached to a patch substrate (e.g., a glass substrate, PCB, etc.) and iris conductor stack 202 comprises one or more iris metal layers attached to an iris substrate (e.g., a glass substrate, PCB, etc. In one embodiment, one or both of patch conductor stack 201 and iris conductor stack 202 contain heater wires for heating the antenna element. In one embodiment, one or both of patch conductor stack 201 and iris conductor stack 202 contain ITO or other similar materials.

In one embodiment, each of patch conductor stack 201 and iris conductor stack 202 contain one or more conductive protection layers covering a side that is adjacent to and contacts alignment layers 204. These conductive layers protect metal layers in patch conductor stack 201 and iris conductor stack 202. In one embodiment, these conductive layers protect metal layers of the conductor stacks from degradation due to the LC. In one embodiment, these conductive layers are inert to the LC. In one embodiment, these conductive layers comprise non-reactive material. In one embodiment, the non-reactive material comprises one or more of ITO, platinum, gold, and a conductive organic layer. In one embodiment, the type of metal of the electrodes impacts selection of the non-reactive material.

In one embodiment, these conductive, protection layers added to patch conductor stack 201 and iris conductor stack 202 increase the size of the conductor stacks. In one embodiment, the thickness of the one or more conductive layers on patch conductor stack 201 and thickness of the one or more conductive layers on iris conductor stack 202 is based on conductivity of the conductive layers with respect to metal layers in the patch and iris conductor stacks, respectively. In one embodiment, the thickness of the conductive protection layer is greater, if its conductivity is higher than metal in the conductor stack it protects, than if its conductivity is lower than the conductor stack it protects. For example, in one embodiment, if the metal layers in the conductor stacks are copper, then a thicker protection layer is used if the protection layer's conductivity is greater than that of copper and a thinner protection layer is used if the protection layer's conductivity is lower than that of copper.

As shown in FIG. 2, the passivation layer that is part of the structure in FIG. 1 has been removed and it's no longer necessary. Therefore, in one embodiment, the structure of each of the antenna elements is without any non-tuning dielectrics between the conductor stacks other than the alignment layers.

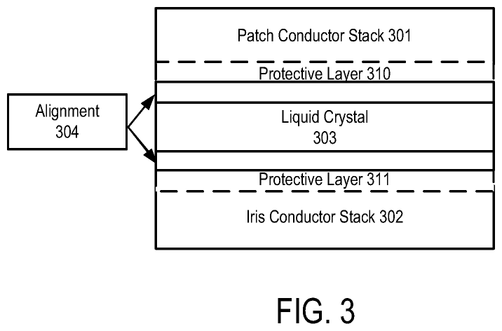

FIG. 3 illustrates one embodiment of a structure of a liquid-crystal (LC)-based metamaterial antenna element having a single, non-conductive protection layer covering each of the patch and iris conductor stacks. Referring to FIG. 3, the structure includes a patch conductor stack 301, iris conductor stack 302, and LC 303 between patch conductor stack 301 and iris conductor stack 302. Alignment layers 304 for aligning the LC during the on and off phases of the antenna element are attached to patch conductor stack 301 and iris conductor stack 302 on the sides adjacent to LC 303. Protection layers 310 and 311 are attached to sides of patch conductor stack 301 and iris conductor stack 203, respectively, that contact and are adjacent to LC 303. In one embodiment, each of conductive protection layers 310 and 311 comprises a single conductive protection layer.

In one embodiment, protection layers 310 and 311 are thick enough to protect the metal layers of conductor stacks 302 and 303, respectively, from degradation from LC 303. In one embodiment, the thickness of protection layers 310 and 311 is also selected to ensure that the gap size between stacks 301 and 302 is sized properly to enable operation of the LC-based antenna element. Note also that protection layers 310 and 311 can have different thicknesses.

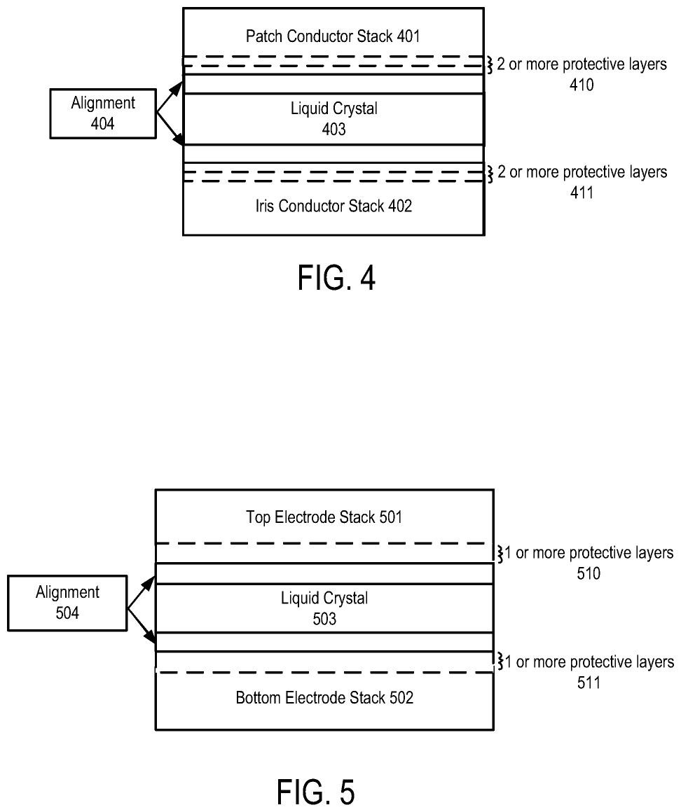

FIG. 4 illustrates one embodiment of a structure of a liquid-crystal (LC)-based metamaterial antenna element having two or more, non-conductive protection layers covering each of the patch and iris conductor stacks. Referring to FIG. 4, the structure includes a patch conductor stack 401, iris conductor stack 402, and LC 403 between patch conductor stack 401 and iris conductor stack 402. Alignment layers 404 for aligning the LC during the on and off phases of the antenna element are attached to patch conductor stack 401 and iris conductor stack 402 on the sides adjacent to LC 403. Conductive protection layers 410 and 411 are attached to sides of patch conductor stack 401 and iris conductor stack 402, respectively, that contact and are adjacent to LC 403. In one embodiment, each of conductive protection layers 410 and 411 comprises two or more conductive protection layers.

In one embodiment, the layers of conductive protection layers 410 may diffuse into each other to offer additional protection to conductor stack 401. Similarly, the layers of conductive protection layers 411 may diffuse into each other to offer additional protection to conductor stack 402. In one embodiment, the two or more layers of protection layers 410 when combined and the two or more layers of protection layers 411 when combined are thick enough to protect the metal layers of conductor stacks 401 and 402, respectively, from degradation from LC 403 while ensuring that the gap size between stacks 401 and 402 is sized properly to enable operation of the LC-based antenna element. In one embodiment, protection layers 410 and 411 have different thicknesses.

In one embodiment, multiple layers are used for one or both of protection layers 410 and 411 because the outer most layer(s) of the protection layers do not adhere to the rest of its corresponding conductor stack adequately or with the desired adherence and another layer (i.e., the inner most layer of the protection layer) is able to adhere (or better adhere) the outer most layer(s) of the protection layers to the rest of its corresponding conductor stack better.

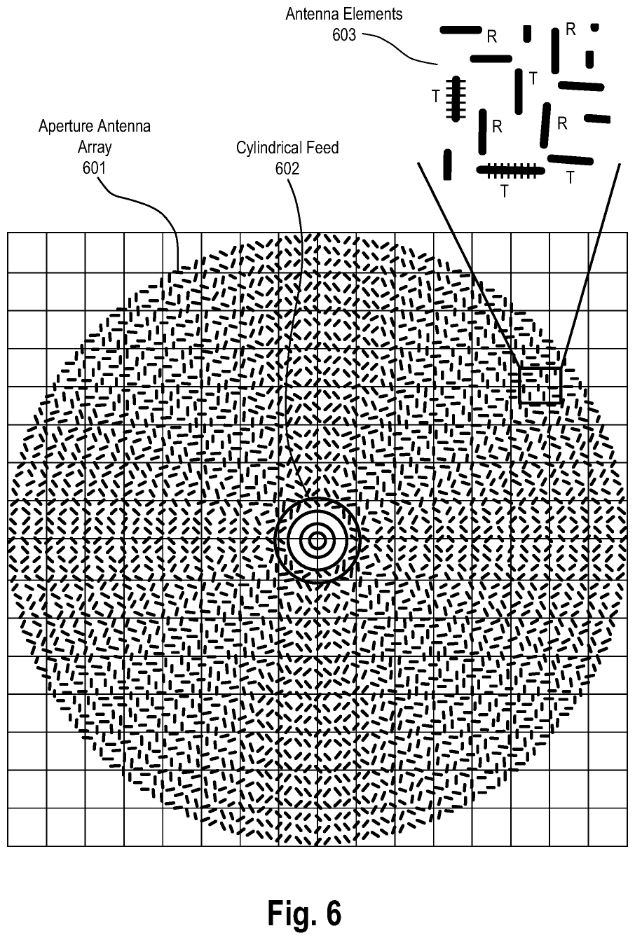

The techniques described herein are not limited to patch and iris-based antenna elements. These techniques may be applied to other electrode-based antenna elements. FIG. 5 illustrates one embodiment of a structure of a liquid-crystal (LC)-based metamaterial antenna element having one or more, conductive protection layers covering each of the top and bottom conductor stacks. Referring to FIG. 5, the structure includes a top electrode stack 501, bottom electrode stack 502 and LC 503 between top electrode stack 501 and bottom electrode stack 502. Alignment layers 504 for aligning the LC during the on and off phases of the antenna element are attached to top electrode stack 501 and bottom electrode stack 502 on the sides adjacent to LC 503. Conductive protection layers 510 and 511 are attached to sides of top electrode stack 501 and bottom electrode stack 502, respectively, that contact and are adjacent to LC 503. In one embodiment, each of conductive protection layers 510 and 511 comprises one or more conductive protection layers.

### Examples of Antenna Embodiments

The techniques described above may be used with flat panel antennas. Embodiments of such flat panel antennas are disclosed. The flat panel antennas include one or more arrays of antenna elements on an antenna aperture. In one embodiment, the antenna elements comprise liquid crystal cells. In one embodiment, the flat panel antenna is a cylindrically fed antenna that includes matrix drive circuitry to uniquely address and drive each of the antenna elements that are not placed in rows and columns. In one embodiment, the elements are placed in rings.

In one embodiment, the antenna aperture having the one or more arrays of antenna elements is comprised of multiple segments coupled together. When coupled together, the combination of the segments form closed concentric rings of antenna elements. In one embodiment, the concentric rings are concentric with respect to the antenna feed.

### Examples of Antenna Systems

In one embodiment, the flat panel antenna is part of a metamaterial antenna system. Embodiments of a metamaterial antenna system for communications satellite earth stations are described. In one embodiment, the antenna system is a component or subsystem of a satellite earth station (ES) operating on a mobile platform (e.g., aeronautical, maritime, land, etc.) that operates using either Ka-band frequencies or Ku-band frequencies for civil commercial satellite communications. Note that embodiments of the antenna system also can be used in earth stations that are not on mobile platforms (e.g., fixed or transportable earth stations).

In one embodiment, the antenna system uses surface scattering metamaterial technology to form and steer transmit and receive beams through separate antennas.

In one embodiment, the antenna system is comprised of three functional subsystems: (1) a wave guiding structure consisting of a cylindrical wave feed architecture; (2) an array of wave scattering metamaterial unit cells that are part of antenna elements; and (3) a control structure to command formation of an adjustable radiation field (beam) from the metamaterial scattering elements using holographic principles.

### Antenna Elements

FIG. 6 illustrates the schematic of one embodiment of a cylindrically fed holographic radial aperture antenna. Referring to FIG. 6, the antenna aperture has one or more arrays 601 of antenna elements 603 that are placed in concentric rings around an input feed 602 of the cylindrically fed antenna. In one embodiment, antenna elements 603 are radio frequency (RF) resonators that radiate RF energy. In one embodiment, antenna elements 603 comprise both Rx and Tx irises that are interleaved and distributed on the whole surface of the antenna aperture. Examples of such antenna elements are described in greater detail below. Note that the RF resonators described herein may be used in antennas that do not include a cylindrical feed.

In one embodiment, the antenna includes a coaxial feed that is used to provide a cylindrical wave feed via input feed 602. In one embodiment, the cylindrical wave feed architecture feeds the antenna from a central point with an excitation that spreads outward in a cylindrical manner from the feed point. That is, a cylindrically fed antenna creates an outward travelling concentric feed wave. Even so, the shape of the cylindrical feed antenna around the cylindrical feed can be circular, square or any shape. In another embodiment, a cylindrically fed antenna creates an inward travelling feed wave. In such a case, the feed wave most naturally comes from a circular structure.

In one embodiment, antenna elements 603 comprise irises and the aperture antenna of FIG. 6 is used to generate a main beam shaped by using excitation from a cylindrical feed wave for radiating irises through tunable liquid crystal (LC) material. In one embodiment, the antenna can be excited to radiate a horizontally or vertically polarized electric field at desired scan angles.

In one embodiment, the antenna elements comprise a group of patch antennas. This group of patch antennas comprises an array of scattering metamaterial elements. In one embodiment, each scattering element in the antenna system is part of a unit cell that consists of a lower conductor, a dielectric substrate and an upper conductor that embeds a complementary electric inductive-capacitive resonator (“complementary electric LC” or “CELC”) that is etched in or deposited onto the upper conductor. As would be understood by those skilled in the art, LC in the context of CELC refers to inductance-capacitance, as opposed to liquid crystal.

In one embodiment, a liquid crystal (LC) is disposed in the gap around the scattering element. This LC is driven by the direct drive embodiments described above. In one embodiment, liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, in one embodiment, the liquid crystal integrates an on/off switch for the transmission of energy from the guided wave to the CELC. When switched on, the CELC emits an electromagnetic wave like an electrically small dipole antenna. Note that the teachings herein are not limited to having a liquid crystal that operates in a binary fashion with respect to energy transmission.

In one embodiment, the feed geometry of this antenna system allows the antenna elements to be positioned at forty-five-degree (45°) angles to the vector of the wave in the wave feed. Note that other positions may be used (e.g., at 40° angles). This position of the elements enables control of the free space wave received by or transmitted/radiated from the elements. In one embodiment, the antenna elements are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In one embodiment, the two sets of elements are perpendicular to each other and simultaneously have equal amplitude excitation if controlled to the same tuning state. Rotating them +/−45 degrees relative to the feed wave excitation achieves both desired features at once. Rotating one set 0 degrees and the other 90 degrees would achieve the perpendicular goal, but not the equal amplitude excitation goal. Note that 0 and 90 degrees may be used to achieve isolation when feeding the array of antenna elements in a single structure from two sides.

The amount of radiated power from each unit cell is controlled by applying a voltage to the patch (potential across the LC channel) using a controller. Traces to each patch are used to provide the voltage to the patch antenna. The voltage is used to tune or detune the capacitance and thus the resonance frequency of individual elements to effectuate beam forming. The voltage required is dependent on the liquid crystal mixture being used. The voltage tuning characteristic of liquid crystal mixtures is mainly described by a threshold voltage at which the liquid crystal starts to be affected by the voltage and the saturation voltage, above which an increase of the voltage does not cause major tuning in liquid crystal. These two characteristic parameters can change for different liquid crystal mixtures.

In one embodiment, as discussed above, a matrix drive is used to apply voltage to the patches in order to drive each cell separately from all the other cells without having a separate connection for each cell (direct drive). Because of the high density of elements, the matrix drive is an efficient way to address each cell individually.

In one embodiment, the control structure for the antenna system has 2 main components: the antenna array controller, which includes drive electronics, for the antenna system, is below the wave scattering structure, while the matrix drive switching array is interspersed throughout the radiating RF array in such a way as to not interfere with the radiation. In one embodiment, the drive electronics for the antenna system comprise commercial off-the shelf LCD controls used in commercial television appliances that adjust the bias voltage for each scattering element by adjusting the amplitude or duty cycle of an AC bias signal to that element.

In one embodiment, the antenna array controller also contains a microprocessor executing the software. The control structure may also incorporate sensors (e.g., a GPS receiver, a three-axis compass, a 3-axis accelerometer, 3-axis gyro, 3-axis magnetometer, etc.) to provide location and orientation information to the processor. The location and orientation information may be provided to the processor by other systems in the earth station and/or may not be part of the antenna system.

More specifically, the antenna array controller controls which elements are turned off and those elements turned on and at which phase and amplitude level at the frequency of operation. The elements are selectively detuned for frequency operation by voltage application.

For transmission, a controller supplies an array of voltage signals to the RF patches to create a modulation, or control pattern. The control pattern causes the elements to be turned to different states. In one embodiment, multistate control is used in which various elements are turned on and off to varying levels, further approximating a sinusoidal control pattern, as opposed to a square wave (i.e., a sinusoid gray shade modulation pattern). In one embodiment, some elements radiate more strongly than others, rather than some elements radiate and some do not. Variable radiation is achieved by applying specific voltage levels, which adjusts the liquid crystal permittivity to varying amounts, thereby detuning elements variably and causing some elements to radiate more than others.

The generation of a focused beam by the metamaterial array of elements can be explained by the phenomenon of constructive and destructive interference. Individual electromagnetic waves sum up (constructive interference) if they have the same phase when they meet in free space and waves cancel each other (destructive interference) if they are in opposite phase when they meet in free space. If the slots in a slotted antenna are positioned so that each successive slot is positioned at a different distance from the excitation point of the guided wave, the scattered wave from that element will have a different phase than the scattered wave of the previous slot. If the slots are spaced one quarter of a guided wavelength apart, each slot will scatter a wave with a one fourth phase delay from the previous slot.

Using the array, the number of patterns of constructive and destructive interference that can be produced can be increased so that beams can be pointed theoretically in any direction plus or minus ninety degrees (90°) from the bore sight of the antenna array, using the principles of holography. Thus, by controlling which metamaterial unit cells are turned on or off (i.e., by changing the pattern of which cells are turned on and which cells are turned off), a different pattern of constructive and destructive interference can be produced, and the antenna can change the direction of the main beam. The time required to turn the unit cells on and off dictates the speed at which the beam can be switched from one location to another location.

In one embodiment, the antenna system produces one steerable beam for the uplink antenna and one steerable beam for the downlink antenna. In one embodiment, the antenna system uses metamaterial technology to receive beams and to decode signals from the satellite and to form transmit beams that are directed toward the satellite. In one embodiment, the antenna systems are analog systems, in contrast to antenna systems that employ digital signal processing to electrically form and steer beams (such as phased array antennas). In one embodiment, the antenna system is considered a “surface” antenna that is planar and relatively low profile, especially when compared to conventional satellite dish receivers.

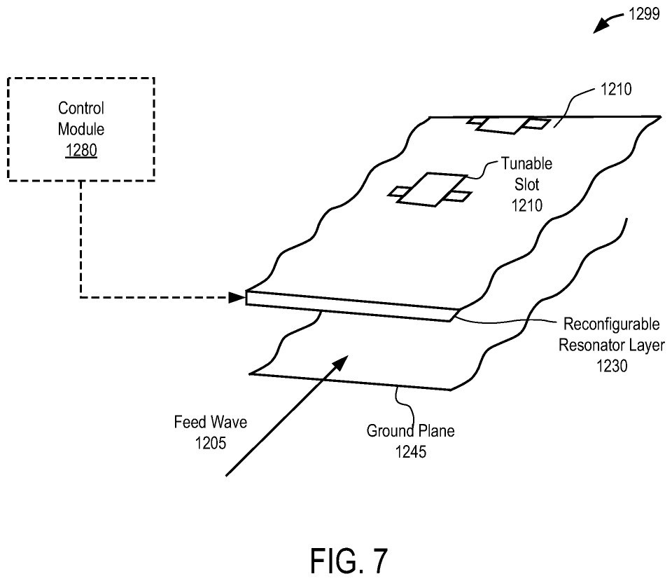

FIG. 7 illustrates a perspective view of one row of antenna elements that includes a ground plane and a reconfigurable resonator layer. Reconfigurable resonator layer 1230 includes an array of tunable slots 1210. The array of tunable slots 1210 can be configured to point the antenna in a desired direction. Each of the tunable slots can be tuned/adjusted by varying a voltage across the liquid crystal.

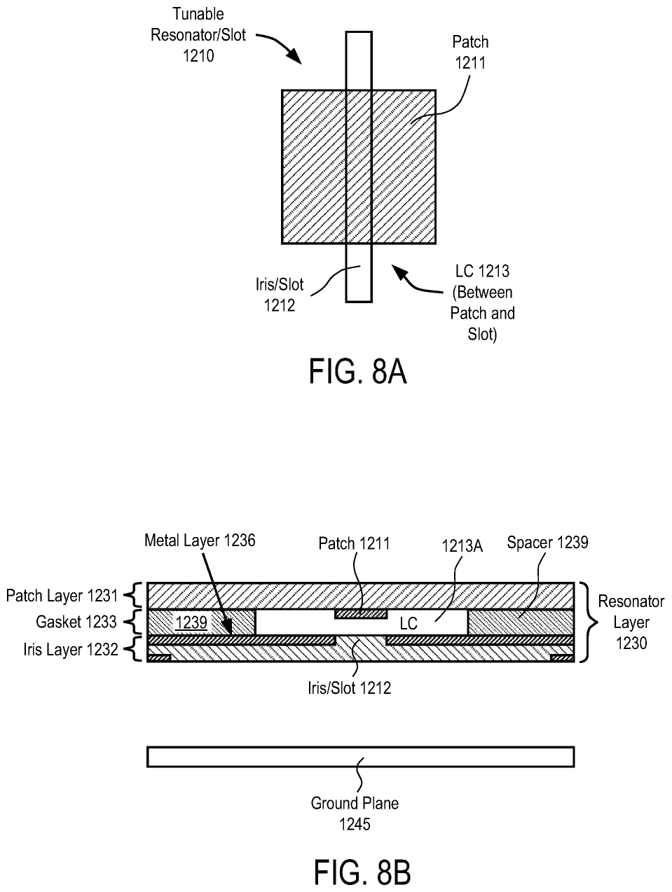

Control module 1280 is coupled to reconfigurable resonator layer 1230 to modulate the array of tunable slots 1210 by varying the voltage across the liquid crystal in FIG. 8A. Control module 1280 may include a Field Programmable Gate Array (“FPGA”), a microprocessor, a controller, System-on-a-Chip (SoC), or other processing logic. In one embodiment, control module 1280 includes logic circuitry (e.g., multiplexer) to drive the array of tunable slots 1210. In one embodiment, control module 1280 receives data that includes specifications for a holographic diffraction pattern to be driven onto the array of tunable slots 1210. The holographic diffraction patterns may be generated in response to a spatial relationship between the antenna and a satellite so that the holographic diffraction pattern steers the downlink beams (and uplink beam if the antenna system performs transmit) in the appropriate direction for communication. Although not drawn in each figure, a control module similar to control module 1280 may drive each array of tunable slots described in the figures of the disclosure.

Radio Frequency (“RF”) holography is also possible using analogous techniques where a desired RF beam can be generated when an RF reference beam encounters an RF holographic diffraction pattern. In the case of satellite communications, the reference beam is in the form of a feed wave, such as feed wave 1205 (approximately 20 GHz in some embodiments). To transform a feed wave into a radiated beam (either for transmitting or receiving purposes), an interference pattern is calculated between the desired RF beam (the object beam) and the feed wave (the reference beam). The interference pattern is driven onto the array of tunable slots 1210 as a diffraction pattern so that the feed wave is “steered” into the desired RF beam (having the desired shape and direction). In other words, the feed wave encountering the holographic diffraction pattern “reconstructs” the object beam, which is formed according to design requirements of the communication system. The holographic diffraction pattern contains the excitation of each element and is calculated by w_{hologram}=w*ᵢₙwₒᵤₜ, with wᵢₙ as the wave equation in the waveguide and wₒᵤₜ the wave equation on the outgoing wave.

FIG. 8A illustrates one embodiment of a tunable resonator/slot 1210. Tunable slot 1210 includes an iris/slot 1212, a radiating patch 1211, and liquid crystal 1213 disposed between iris 1212 and patch 1211. In one embodiment, radiating patch 1211 is co-located with iris 1212.

FIG. 8B illustrates a cross section view of one embodiment of a physical antenna aperture. The antenna aperture includes ground plane 1245, and a metal layer 1236 within iris layer 1232, which is included in reconfigurable resonator layer 1230. In one embodiment, the antenna aperture of FIG. 8B includes a plurality of tunable resonator/slots 1210 of FIG. 8A. Iris/slot 1212 is defined by openings in metal layer 1236. A feed wave, such as feed wave 1205 of FIG. 8A, may have a microwave frequency compatible with satellite communication channels. The feed wave propagates between ground plane 1245 and resonator layer 1230.

Reconfigurable resonator layer 1230 also includes gasket layer 1233 and patch layer 1231. Gasket layer 1233 is disposed between patch layer 1231 and iris layer 1232. Note that in one embodiment, a spacer could replace gasket layer 1233. In one embodiment, iris layer 1232 is a printed circuit board (“PCB”) that includes a copper layer as metal layer 1236. In one embodiment, iris layer 1232 is glass. Iris layer 1232 may be other types of substrates.

Openings may be etched in the copper layer to form slots 1212. In one embodiment, iris layer 1232 is conductively coupled by a conductive bonding layer to another structure (e.g., a waveguide) in FIG. 8B. Note that in an embodiment the iris layer is not conductively coupled by a conductive bonding layer and is instead interfaced with a non-conducting bonding layer.

Patch layer 1231 may also be a PCB that includes metal as radiating patches 1211. In one embodiment, gasket layer 1233 includes spacers 1239 that provide a mechanical standoff to define the dimension between metal layer 1236 and patch 1211. In one embodiment, the spacers are 75 microns, but other sizes may be used (e.g., 3-200 mm). As mentioned above, in one embodiment, the antenna aperture of FIG. 8B includes multiple tunable resonator/slots, such as tunable resonator/slot 1210 includes patch 1211, liquid crystal 1213, and iris 1212 of FIG. 8A. The chamber for liquid crystal 1213A is defined by spacers 1239, iris layer 1232 and metal layer 1236. When the chamber is filled with liquid crystal, patch layer 1231 can be laminated onto spacers 1239 to seal liquid crystal within resonator layer 1230.

A voltage between patch layer 1231 and iris layer 1232 can be modulated to tune the liquid crystal in the gap between the patch and the slots (e.g., tunable resonator/slot 1210). Adjusting the voltage across liquid crystal 1213 varies the capacitance of a slot (e.g., tunable resonator/slot 1210). Accordingly, the reactance of a slot (e.g., tunable resonator/slot 1210) can be varied by changing the capacitance. Resonant frequency of slot 1210 also changes according to the equation

$$f = \frac{1}{2 π \sqrt{L C}}$$

where f is the resonant frequency of slot 1210 and L and C are the inductance and capacitance of slot 1210, respectively. The resonant frequency of slot 1210 affects the energy radiated from feed wave 1205 propagating through the waveguide. As an example, if feed wave 1205 is 20 GHz, the resonant frequency of a slot 1210 may be adjusted (by varying the capacitance) to 17 GHz so that the slot 1210 couples substantially no energy from feed wave 1205. Or, the resonant frequency of a slot 1210 may be adjusted to 20 GHz so that the slot 1210 couples energy from feed wave 1205 and radiates that energy into free space. Although the examples given are binary (fully radiating or not radiating at all), full gray scale control of the reactance, and therefore the resonant frequency of slot 1210 is possible with voltage variance over a multi-valued range. Hence, the energy radiated from each slot 1210 can be finely controlled so that detailed holographic diffraction patterns can be formed by the array of tunable slots.

In one embodiment, tunable slots in a row are spaced from each other by λ/5. Other spacings may be used. In one embodiment, each tunable slot in a row is spaced from the closest tunable slot in an adjacent row by λ/2, and, thus, commonly oriented tunable slots in different rows are spaced by λ/4, though other spacings are possible (e.g., λ/5, λ/6.3). In another embodiment, each tunable slot in a row is spaced from the closest tunable slot in an adjacent row by λ/3.

Embodiments use reconfigurable metamaterial technology, such as described in U.S. patent application Ser. No. 14/550,178, entitled “Dynamic Polarization and Coupling Control from a Steerable Cylindrically Fed Holographic Antenna”, filed Nov. 21, 2014 and U.S. patent application Ser. No. 14/610,502, entitled “Ridged Waveguide Feed Structures for Reconfigurable Antenna”, filed Jan. 30, 2015.

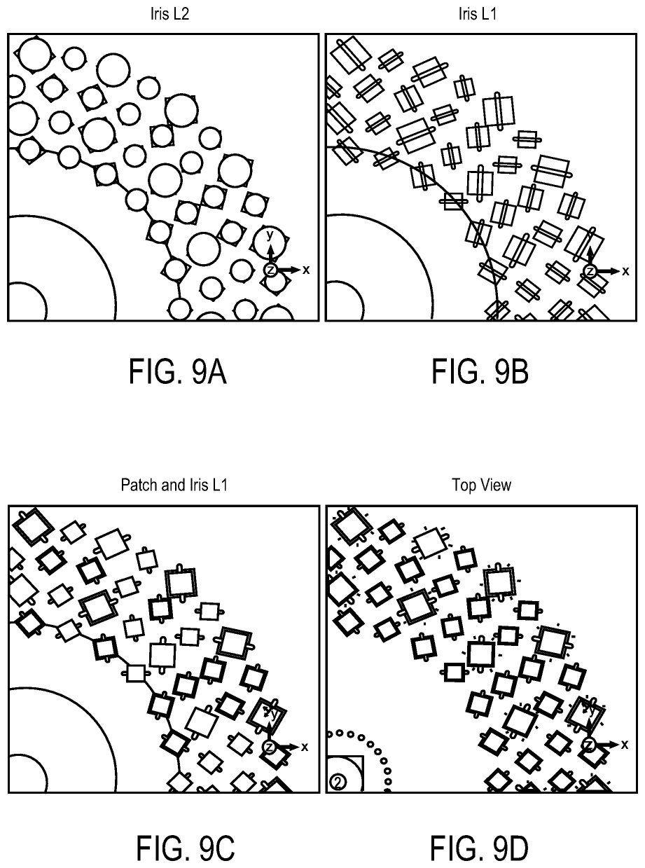

FIGS. 9A-D illustrate one embodiment of the different layers for creating the slotted array. The antenna array includes antenna elements that are positioned in rings, such as the example rings shown in FIG. 6. Note that in this example the antenna array has two different types of antenna elements that are used for two different types of frequency bands.

FIG. 9A illustrates a portion of the first iris board layer with locations corresponding to the slots. Referring to FIG. 9A, the circles are open areas/slots in the metallization in the bottom side of the iris substrate, and are for controlling the coupling of elements to the feed (the feed wave). Note that this layer is an optional layer and is not used in all designs. FIG. 9B illustrates a portion of the second iris board layer containing slots. FIG. 9C illustrates patches over a portion of the second iris board layer. FIG. 9D illustrates a top view of a portion of the slotted array.

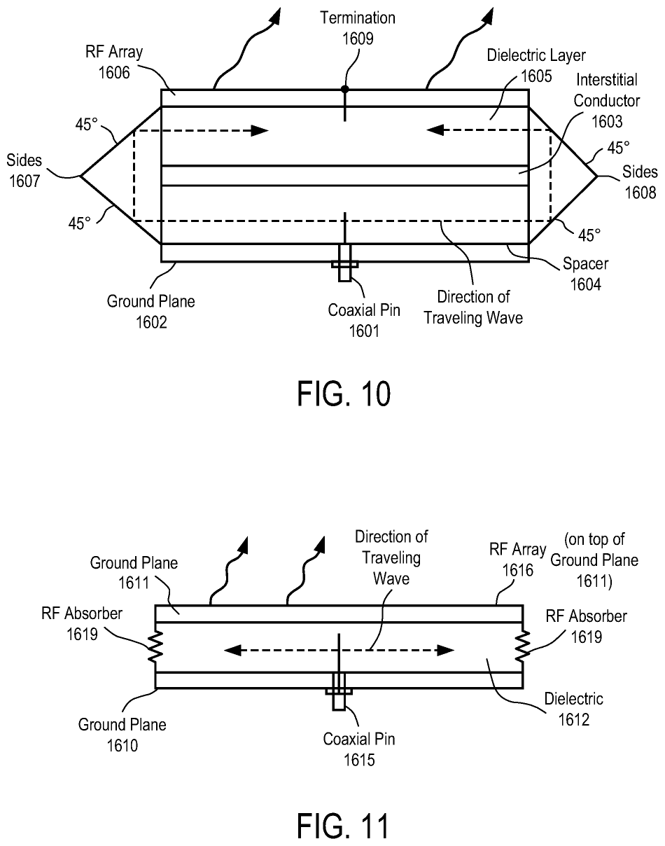

FIG. 10 illustrates a side view of one embodiment of a cylindrically fed antenna structure. The antenna produces an inwardly travelling wave using a double layer feed structure (i.e., two layers of a feed structure). In one embodiment, the antenna includes a circular outer shape, though this is not required. That is, non-circular inward travelling structures can be used. In one embodiment, the antenna structure in FIG. 10 includes a coaxial feed, such as, for example, described in U.S. Publication No. 2015/0236412, entitled “Dynamic Polarization and Coupling Control from a Steerable Cylindrically Fed Holographic Antenna”, filed on Nov. 21, 2014.

Referring to FIG. 10, a coaxial pin 1601 is used to excite the field on the lower level of the antenna. In one embodiment, coaxial pin 1601 is a 50Ω coax pin that is readily available. Coaxial pin 1601 is coupled (e.g., bolted) to the bottom of the antenna structure, which is conducting ground plane 1602.

Separate from conducting ground plane 1602 is interstitial conductor 1603, which is an internal conductor. In one embodiment, conducting ground plane 1602 and interstitial conductor 1603 are parallel to each other. In one embodiment, the distance between ground plane 1602 and interstitial conductor 1603 is 0.1-0.15″. In another embodiment, this distance may be λ/2, where λ, is the wavelength of the travelling wave at the frequency of operation.

Ground plane 1602 is separated from interstitial conductor 1603 via a spacer 1604. In one embodiment, spacer 1604 is a foam or air-like spacer. In one embodiment, spacer 1604 comprises a plastic spacer.

On top of interstitial conductor 1603 is dielectric layer 1605. In one embodiment, dielectric layer 1605 is plastic. The purpose of dielectric layer 1605 is to slow the travelling wave relative to free space velocity. In one embodiment, dielectric layer 1605 slows the travelling wave by 30% relative to free space. In one embodiment, the range of indices of refraction that are suitable for beam forming are 1.2-1.8, where free space has by definition an index of refraction equal to 1. Other dielectric spacer materials, such as, for example, plastic, may be used to achieve this effect. Note that materials other than plastic may be used as long as they achieve the desired wave slowing effect. Alternatively, a material with distributed structures may be used as dielectric 1605, such as periodic sub-wavelength metallic structures that can be machined or lithographically defined, for example.

An RF-array 1606 is on top of dielectric 1605. In one embodiment, the distance between interstitial conductor 1603 and RF-array 1606 is 0.1-0.15″. In another embodiment, this distance may be λ_{eff}/2, where λ_{eff} is the effective wavelength in the medium at the design frequency.

The antenna includes sides 1607 and 1608. Sides 1607 and 1608 are angled to cause a travelling wave feed from coax pin 1601 to be propagated from the area below interstitial conductor 1603 (the spacer layer) to the area above interstitial conductor 1603 (the dielectric layer) via reflection. In one embodiment, the angle of sides 1607 and 1608 are at 45° angles. In an alternative embodiment, sides 1607 and 1608 could be replaced with a continuous radius to achieve the reflection. While FIG. 10 shows angled sides that have angle of 45 degrees, other angles that accomplish signal transmission from lower-level feed to upper-level feed may be used. That is, given that the effective wavelength in the lower feed will generally be different than in the upper feed, some deviation from the ideal 45° angles could be used to aid transmission from the lower to the upper feed level. For example, in another embodiment, the 45° angles are replaced with a single step. The steps on one end of the antenna go around the dielectric layer, interstitial the conductor, and the spacer layer. The same two steps are at the other ends of these layers.

In operation, when a feed wave is fed in from coaxial pin 1601, the wave travels outward concentrically oriented from coaxial pin 1601 in the area between ground plane 1602 and interstitial conductor 1603. The concentrically outgoing waves are reflected by sides 1607 and 1608 and travel inwardly in the area between interstitial conductor 1603 and RF array 1606. The reflection from the edge of the circular perimeter causes the wave to remain in phase (i.e., it is an in-phase reflection). The travelling wave is slowed by dielectric layer 1605. At this point, the travelling wave starts interacting and exciting with elements in RF array 1606 to obtain the desired scattering.

To terminate the travelling wave, a termination 1609 is included in the antenna at the geometric center of the antenna. In one embodiment, termination 1609 comprises a pin termination (e.g., a 50Ω pin). In another embodiment, termination 1609 comprises an RF absorber that terminates unused energy to prevent reflections of that unused energy back through the feed structure of the antenna. These could be used at the top of RF array 1606.

FIG. 11 illustrates another embodiment of the antenna system with an outgoing wave. Referring to FIG. 11, two ground planes 1610 and 1611 are substantially parallel to each other with a dielectric layer 1612 (e.g., a plastic layer, etc.) in between ground planes. RF absorbers 1619 (e.g., resistors) couple the two ground planes 1610 and 1611 together. A coaxial pin 1615 (e.g., 50Ω) feeds the antenna. An RF array 1616 is on top of dielectric layer 1612 and ground plane 1611.

In operation, a feed wave is fed through coaxial pin 1615 and travels concentrically outward and interacts with the elements of RF array 1616.

The cylindrical feed in both the antennas of FIGS. 10 and 11 improves the service angle of the antenna. Instead of a service angle of plus or minus forty-five degrees azimuth (±45° Az) and plus or minus twenty-five degrees elevation (±25° El), in one embodiment, the antenna system has a service angle of seventy-five degrees (75°) from the bore sight in all directions. As with any beam forming antenna comprised of many individual radiators, the overall antenna gain is dependent on the gain of the constituent elements, which themselves are angle-dependent. When using common radiating elements, the overall antenna gain typically decreases as the beam is pointed further off bore sight. At 75 degrees off bore sight, significant gain degradation of about 6 dB is expected.

Embodiments of the antenna having a cylindrical feed solve one or more problems. These include dramatically simplifying the feed structure compared to antennas fed with a corporate divider network and therefore reducing total required antenna and antenna feed volume; decreasing sensitivity to manufacturing and control errors by maintaining high beam performance with coarser controls (extending all the way to simple binary control); giving a more advantageous side lobe pattern compared to rectilinear feeds because the cylindrically oriented feed waves result in spatially diverse side lobes in the far field; and allowing polarization to be dynamic, including allowing left-hand circular, right-hand circular, and linear polarizations, while not requiring a polarizer.

### Array of Wave Scattering Elements

RF array 1606 of FIG. 10 and RF array 1616 of FIG. 11 include a wave scattering subsystem that includes a group of patch antennas (i.e., scatterers) that act as radiators. This group of patch antennas comprises an array of scattering metamaterial elements.

In one embodiment, each scattering element in the antenna system is part of a unit cell that consists of a lower conductor, a dielectric substrate and an upper conductor that embeds a complementary electric inductive-capacitive resonator (“complementary electric LC” or “CELC”) that is etched in or deposited onto the upper conductor.

In one embodiment, a liquid crystal (LC) is injected in the gap around the scattering element. Liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, the liquid crystal acts as an on/off switch for the transmission of energy from the guided wave to the CELC. When switched on, the CELC emits an electromagnetic wave like an electrically small dipole antenna.

Controlling the thickness of the LC increases the beam switching speed. A fifty percent (50%) reduction in the gap between the lower and the upper conductor (the thickness of the liquid crystal) results in a fourfold increase in speed. In another embodiment, the thickness of the liquid crystal results in a beam switching speed of approximately fourteen milliseconds (14 ms). In one embodiment, the LC is doped in a manner well-known in the art to improve responsiveness so that a seven millisecond (7 ms) requirement can be met.

The CELC element is responsive to a magnetic field that is applied parallel to the plane of the CELC element and perpendicular to the CELC gap complement. When a voltage is applied to the liquid crystal in the metamaterial scattering unit cell, the magnetic field component of the guided wave induces a magnetic excitation of the CELC, which, in turn, produces an electromagnetic wave in the same frequency as the guided wave.

The phase of the electromagnetic wave generated by a single CELC can be selected by the position of the CELC on the vector of the guided wave. Each cell generates a wave in phase with the guided wave parallel to the CELC. Because the CELCs are smaller than the wave length, the output wave has the same phase as the phase of the guided wave as it passes beneath the CELC.

In one embodiment, the cylindrical feed geometry of this antenna system allows the CELC elements to be positioned at forty-five-degree (45°) angles to the vector of the wave in the wave feed. This position of the elements enables control of the polarization of the free space wave generated from or received by the elements. In one embodiment, the CELCs are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In one embodiment, the CELCs are implemented with patch antennas that include a patch co-located over a slot with liquid crystal between the two. In this respect, the metamaterial antenna acts like a slotted (scattering) wave guide. With a slotted wave guide, the phase of the output wave depends on the location of the slot in relation to the guided wave.

### Cell Placement

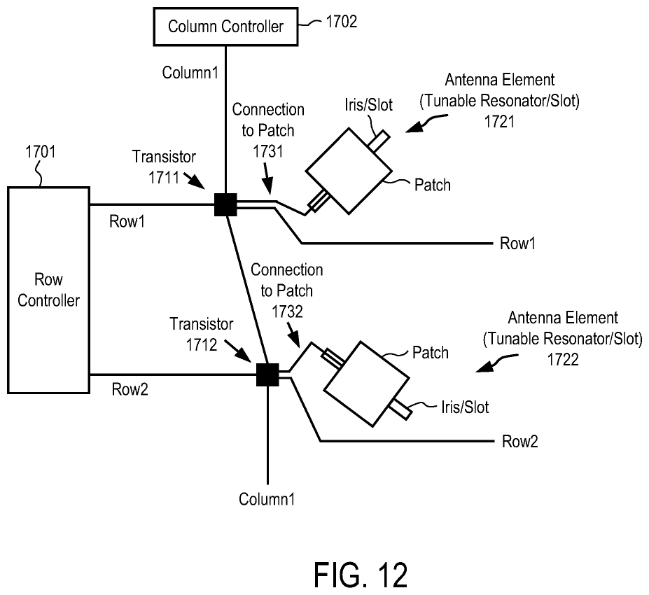

In one embodiment, the antenna elements are placed on the cylindrical feed antenna aperture in a way that allows for a systematic matrix drive circuit. The placement of the cells includes placement of the transistors for the matrix drive. FIG. 12 illustrates one embodiment of the placement of matrix drive circuitry with respect to antenna elements. Referring to FIG. 12, row controller 1701 is coupled to transistors 1711 and 1712, via row select signals Row1 and Row2, respectively, and column controller 1702 is coupled to transistors 1711 and 1712 via column select signal Column1. Transistor 1711 is also coupled to antenna element 1721 via connection to patch 1731, while transistor 1712 is coupled to antenna element 1722 via connection to patch 1732.

In an initial approach to realize matrix drive circuitry on the cylindrical feed antenna with unit cells placed in a non-regular grid, two steps are performed. In the first step, the cells are placed on concentric rings and each of the cells is connected to a transistor that is placed beside the cell and acts as a switch to drive each cell separately. In the second step, the matrix drive circuitry is built in order to connect every transistor with a unique address as the matrix drive approach requires. Because the matrix drive circuit is built by row and column traces (similar to LCDs) but the cells are placed on rings, there is no systematic way to assign a unique address to each transistor. This mapping problem results in very complex circuitry to cover all the transistors and leads to a significant increase in the number of physical traces to accomplish the routing. Because of the high density of cells, those traces disturb the RF performance of the antenna due to coupling effect. Also, due to the complexity of traces and high packing density, the routing of the traces cannot be accomplished by commercially available layout tools.

In one embodiment, the matrix drive circuitry is predefined before the cells and transistors are placed. This ensures a minimum number of traces that are necessary to drive all the cells, each with a unique address. This strategy reduces the complexity of the drive circuitry and simplifies the routing, which subsequently improves the RF performance of the antenna.

More specifically, in one approach, in the first step, the cells are placed on a regular rectangular grid composed of rows and columns that describe the unique address of each cell. In the second step, the cells are grouped and transformed to concentric circles while maintaining their address and connection to the rows and columns as defined in the first step. A goal of this transformation is not only to put the cells on rings but also to keep the distance between cells and the distance between rings constant over the entire aperture. In order to accomplish this goal, there are several ways to group the cells.

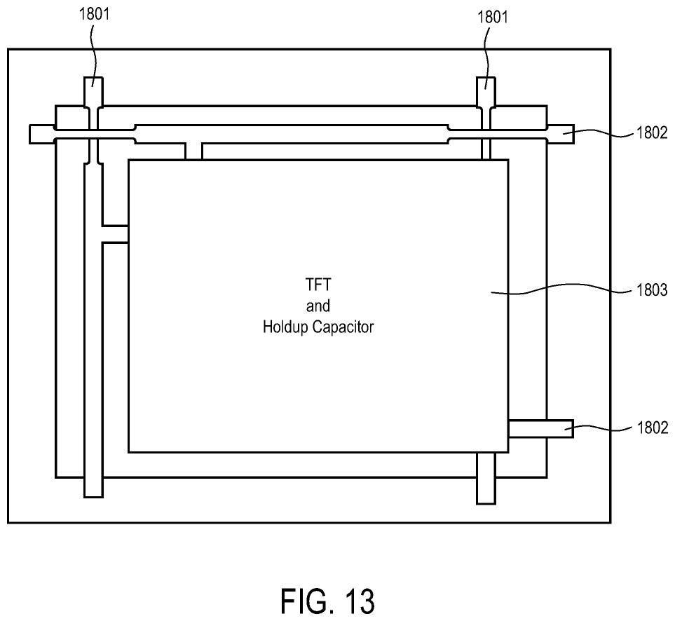

In one embodiment, a TFT package is used to enable placement and unique addressing in the matrix drive. FIG. 13 illustrates one embodiment of a TFT package. Referring to FIG. 13, a TFT and a hold capacitor 1803 is shown with input and output ports. There are two input ports connected to traces 1801 and two output ports connected to traces 1802 to connect the TFTs together using the rows and columns. In one embodiment, the row and column traces cross in 90° angles to reduce, and potentially minimize, the coupling between the row and column traces. In one embodiment, the row and column traces are on different layers.

### An Example of a Full Duplex Communication System

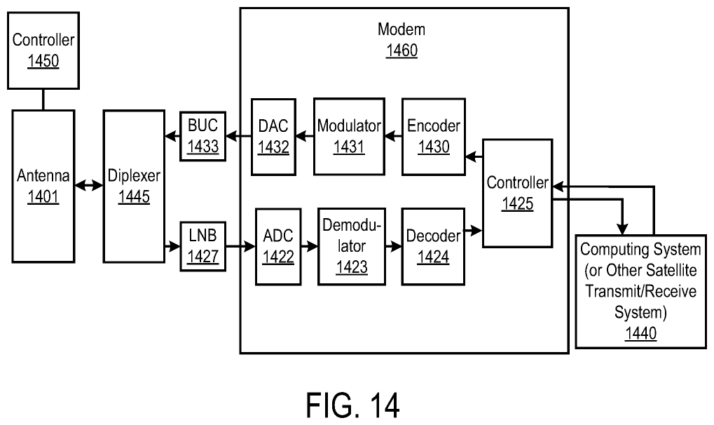

In another embodiment, the combined antenna apertures are used in a full duplex communication system. FIG. 14 is a block diagram of another embodiment of a communication system having simultaneous transmit and receive paths. While only one transmit path and one receive path are shown, the communication system may include more than one transmit path and/or more than one receive path.

Referring to FIG. 14, antenna 1401 includes two spatially interleaved antenna arrays operable independently to transmit and receive simultaneously at different frequencies as described above. In one embodiment, antenna 1401 is coupled to diplexer 1445. The coupling may be by one or more feeding networks. In one embodiment, in the case of a radial feed antenna, diplexer 1445 combines the two signals and the connection between antenna 1401 and diplexer 1445 is a single broad-band feeding network that can carry both frequencies.

Diplexer 1445 is coupled to a low noise block down converter (LNB) 1427, which performs a noise filtering function and a down conversion and amplification function in a manner well-known in the art. In one embodiment, LNB 1427 is in an out-door unit (ODU). In another embodiment, LNB 1427 is integrated into the antenna apparatus. LNB 1427 is coupled to a modem 1460, which is coupled to computing system 1440 (e.g., a computer system, modem, etc.).

Modem 1460 includes an analog-to-digital converter (ADC) 1422, which is coupled to LNB 1427, to convert the received signal output from diplexer 1445 into digital format. Once converted to digital format, the signal is demodulated by demodulator 1423 and decoded by decoder 1424 to obtain the encoded data on the received wave. The decoded data is then sent to controller 1425, which sends it to computing system 1440.

Modem 1460 also includes an encoder 1430 that encodes data to be transmitted from computing system 1440. The encoded data is modulated by modulator 1431 and then converted to analog by digital-to-analog converter (DAC) 1432. The analog signal is then filtered by a BUC (up-convert and high pass amplifier) 1433 and provided to one port of diplexer 1445. In one embodiment, BUC 1433 is in an out-door unit (ODU).

Diplexer 1445 operating in a manner well-known in the art provides the transmit signal to antenna 1401 for transmission.

Controller 1450 controls antenna 1401, including the two arrays of antenna elements on the single combined physical aperture.

The communication system would be modified to include the combiner/arbiter described above. In such a case, the combiner/arbiter after the modem but before the BUC and LNB.

Note that the full duplex communication system shown in FIG. 14 has a number of applications, including but not limited to, internet communication, vehicle communication (including software updating), etc.

There is a number of example embodiments described herein.

Example 1 is an antenna comprising an array of radio-frequency (RF) radiating antenna elements, wherein each RF radiating antenna element comprises a first conductor stack containing one or more metal layers and having a first set of one or more conductive layers covering a first side of the first conductive stack; a second conductor stack, separated from the first conductor stack, containing one or more conductive layers and having a second set of one or more conductive layers covering a second side of the second conductive stack; and liquid crystal (LC) between the first and second sides of the first and second conductor stacks, respectively.

Example 2 is the antenna of example 1 that may optionally include that the first and second sets of conductive layers protect the one or more metal layers from degradation due to the LC.

Example 3 is the antenna of example 2 that may optionally include that the first and second sets of conductive layers are inert to the LC.

Example 4 is the antenna of example 2 that may optionally include that the first and second sets of conductive layers comprise material non-reactive to the LC.

Example 5 is the antenna of example 4 that may optionally include that the non-reactive material comprises one or more of ITO, platinum, gold, and a conductive organic layer.

Example 6 is the antenna of example 1 that may optionally include that thickness of the first set of one or more conductive layers and the second set of one or more conductive layers is based on conductivity of the first set and the second set with respect to metal layers in the first and second conductor stacks, respectively, where the thickness is greater, for at least one set of the first and second sets if conductivity for the at least one set is higher than a metal layer in its respective conductor stack, than if conductivity for the at least one set is lower than a metal layer in its respective conductor stack.

Example 7 is the antenna of example 1 that may optionally include a first alignment layer attached to the first set of conductive layers adjacent the LC and a second alignment layer attached to the second set of conductive layers adjacent the LC.

Example 8 is the antenna of example 7 that may optionally include that each of the antenna elements is without any non-tuning dielectrics between the first and second conductor stacks other than the first and second alignment layers.

Example 9 is the antenna of example 1 that may optionally include that the first conductor stack comprises a patch conductor stack having a patch and the second conductor stack comprises an iris conductor stack having an iris.

Example 10 is the antenna of example 1 that may optionally include that the patch conductor stack comprises one or more patch metal layers attached to a patch substrate and the iris conductor stack comprises one or more iris metal layers attached to an iris substrate.

Example 11 is the antenna of example 1 that may optionally include that the RF radiating antenna elements comprises surface scattering metamaterial antenna elements.

Example 12 is an antenna comprising: an array of radio-frequency (RF) radiating antenna elements, wherein each RF radiating antenna element comprises a patch conductor stack containing one or more metal layers; a first set of one or more conductive layers covering a first side of the first conductive stack; an iris conductor stack, separated from the patch conductor stack; a second set of one or more conductive layers covering a second side of the iris conductive stack; liquid crystal (LC) between the first and second sets of one or more conductive layers; and a first alignment layer attached to the first set of one or more conductive layers adjacent the LC and a second alignment layer attached to the second set of one or more conductive layers adjacent the LC.

Example 13 is the antenna of example 12 that may optionally include that the first and second sets of conductive layers protect the one or more metal layers from degradation due to the LC.

Example 14 is the antenna of example 13 that may optionally include that the first and second sets of conductive layers are inert to the LC.

Example 15 is the antenna of example 13 that may optionally include that the first and second sets of conductive layers comprise material non-reactive to the LC.

Example 16 is the antenna of example 15 that may optionally include that the non-reactive material comprises one or more of ITO, platinum, gold, and a conductive organic layer.

Example 17 is the antenna of example 12 that may optionally include that thickness of the first set of one or more conductive layers and the second set of one or more conductive layers is based on conductivity of the first set and the second set with respect to metal layers in the first and second conductor stacks, respectively, wherein the thickness is greater, for at least one set of the first and second sets if conductivity for the at least one set is higher than a metal layer in its respective conductor stack, than if conductivity for the at least one set is lower than a metal layer in its respective conductor stack.

Example 18 is the antenna of example 12 that may optionally include that each of the antenna elements is without any non-tuning dielectrics between the first and second conductor stacks other than the first and second alignment layers.

Example 19 is the antenna of example 12 that may optionally include that the patch conductor stack comprises one or more patch metal layers attached to a patch substrate and the iris conductor stack comprises one or more iris metal layers attached to an iris substrate.

Example 20 is the antenna of example 12 that may optionally include that the RF radiating antenna elements comprises surface scattering metamaterial antenna elements.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. An antenna comprising:
an array of radio-frequency (RF) radiating antenna elements, wherein each RF radiating antenna element comprises
a first conductor stack containing one or more metal layers and having a first set of one or more conductive layers covering a first side of the first conductive stack;
a second conductor stack, separated from the first conductor stack, containing one or more conductive layers and having a second set of one or more conductive layers covering a second side of the second conductive stack; and
liquid crystal (LC) between the first and second sides of the first and second conductor stacks, respectively.

2. The antenna of claim 1 wherein the first and second sets of conductive layers protect the one or more metal layers from degradation due to the LC.

3. The antenna of claim 2 wherein the first and second sets of conductive layers are inert to the LC.

4. The antenna of claim 2 wherein the first and second sets of conductive layers comprise material non-reactive to the LC.

5. The antenna of claim 4 wherein the non-reactive material comprises one or more of ITO, platinum, gold, and a conductive organic layer.

6. The antenna of claim 1 wherein thickness of the first set of one or more conductive layers and the second set of one or more conductive layers is based on conductivity of the first set and the second set with respect to metal layers in the first and second conductor stacks, respectively, the thickness being greater, for at least one set of the first and second sets if conductivity for the at least one set is higher than a metal layer in its respective conductor stack, than if conductivity for the at least one set is lower than a metal layer in its respective conductor stack.

7. The antenna of claim 1 further comprising a first alignment layer attached to the first set of conductive layers adjacent the LC and a second alignment layer attached to the second set of conductive layers adjacent the LC.

8. The antenna of claim 7 wherein each of the antenna elements is without any non-tuning dielectrics between the first and second conductor stacks other than the first and second alignment layers.

9. The antenna of claim 1 wherein the first conductor stack comprises a patch conductor stack having a patch and the second conductor stack comprises an iris conductor stack having an iris.

10. The antenna of claim 1 wherein the patch conductor stack comprises one or more patch metal layers attached to a patch substrate and the iris conductor stack comprises one or more iris metal layers attached to an iris substrate.

11. The antenna of claim 1 wherein the RF radiating antenna elements comprises surface scattering metamaterial antenna elements.

12. An antenna comprising:
an array of radio-frequency (RF) radiating antenna elements, wherein each RF radiating antenna element comprises
a patch conductor stack containing one or more metal layers;
a first set of one or more conductive layers covering a first side of the first conductive stack;
an iris conductor stack, separated from the patch conductor stack;
a second set of one or more conductive layers covering a second side of the iris conductive stack;
liquid crystal (LC) between the first and second sets of one or more conductive layers; and
a first alignment layer attached to the first set of one or more conductive layers adjacent the LC and a second alignment layer attached to the second set of one or more conductive layers adjacent the LC.

13. The antenna of claim 12 wherein the first and second sets of conductive layers protect the one or more metal layers from degradation due to the LC.

14. The antenna of claim 13 wherein the first and second sets of conductive layers are inert to the LC.

15. The antenna of claim 13 wherein the first and second sets of conductive layers comprise material non-reactive to the LC.

16. The antenna of claim 15 wherein the non-reactive material comprises one or more of ITO, platinum, gold, and a conductive organic layer.

17. The antenna of claim 12 wherein thickness of the first set of one or more conductive layers and the second set of one or more conductive layers is based on conductivity of the first set and the second set with respect to metal layers in the first and second conductor stacks, respectively, the thickness being greater, for at least one set of the first and second sets if conductivity for the at least one set is higher than a metal layer in its respective conductor stack, than if conductivity for the at least one set is lower than a metal layer in its respective conductor stack.

18. The antenna of claim 12 wherein each of the antenna elements is without any non-tuning dielectrics between the first and second conductor stacks other than the first and second alignment layers.

19. The antenna of claim 12 wherein the patch conductor stack comprises one or more patch metal layers attached to a patch substrate and the iris conductor stack comprises one or more iris metal layers attached to an iris substrate.

20. The antenna of claim 12 wherein the RF radiating antenna elements comprises surface scattering metamaterial antenna elements.
